(19) United States
(12) Patent Application Publication
(10) Pub. No.: US 2012/0019704 A1
(43) Pub. Date: Jan. 26, 2012

(54) AUTOMATIC DIGITAL CAMERA PHOTOGRAPHY MODE SELECTION

(76) Inventor: Charles I. Levey, West Henrietta, NY (US)

(21) Appl. No.: 12/843,241

(22) Filed: Jul. 26, 2010

(51) Int. Cl. H04N 5/225

(52) U.S. Cl. 348/335; 348/E05.024

(57) ABSTRACT

A digital camera having a plurality of photography modes, comprising: an imaging sensor; an optical system for imaging a scene onto the imaging sensor; an image capture control for initiating an image capture operation; a photography mode user interface for selecting between a plurality of photography modes, the photography modes having associated image capture and image processing settings; a power control for turning the digital camera on or off, wherein when the camera is in an off state and the power control is activated with a first activation pattern the digital camera is turned on and set to operate in a default photography mode and when the power control is activated with a second activation pattern the digital camera is turned on and set to operate in a previously selected photography mode.

### CROSS-REFERENCE TO RELATED APPLICATIONS

Reference is made to commonly assigned, co-pending U.S. patent application Ser. No. ______ (96374), entitled: “Automatic Digital Camera Photography Mode Selection”, by Frank Razavi et al., which is incorporated herein by reference.

### FIELD OF THE INVENTION

This invention pertains to the field of digital cameras and more particularly to the automatic selection of a photography mode.

### BACKGROUND OF THE INVENTION

Digital cameras with a multitude of operational features including but not limited to exposure control, white balance, auto focus, etc. have been a consumer staple for decades. As camera complexity has increased, required actions by the user to operate digital cameras have increased.

Most digital cameras have a variety of photography modes that can be selected by the user to control various elements of the image capture process and the image processing chain. Examples of typical photography modes include smart capture, portrait, sport, landscape, close-up, sunset, backlight, children, bright, self-portrait, night portrait, night landscape, high-ISO and panorama. Various methods have been described to select an appropriate photography mode and control other digital camera functions. Some digital cameras include mechanical dials that can be used to select the photography mode. However, this adds expense to the digital camera and limits the number of choices that can be offered.

In other digital camera models, the photography mode can be selected by navigating a series of menus on a soft-copy display on the back of the digital camera. Often it can be a lengthy process for the user to navigate through several levels of menus to choose the desired photography mode. Then, if the user turns the camera off and back on again, it is generally necessary to repeat those time-consuming steps again in order to return to the same photography mode. This can be a frustrating experience for the user.

U.S. Pat. No. 6,571,066 to Tsai, entitled “Camera with multimode power button,” describes a method for using the power button to either turn on the camera or select camera operation mode. This scheme requires multiple pushes of the power button to first turn on the camera then select the operating mode.

U.S. Pat. No. 7,721,227 to Ronkainen, entitled “Method for describing alternative actions caused by pushing a single button,” describes a user interface for making a choice between two different actions dependent on how long a button is depressed. If the button is released immediately, a first action is taken. If the button is held for a longer period of time a message is displayed indicating that if the button is continued to be held a second action will be taken. If the button is not released within a specified time interval, the second action is then taken.

U.S. Pat. No. 6,727,830 to Lui, entitled “Time based hardware button for application launch,” teaches the use of a time dependent press of an “application” button to select between various functions. Multiple button presses can also be used to select different functions.

U.S. Pat. No. 6,976,215 to Roderick et al., entitled “Pushbutton user interface with functionality preview,” teaches a user-interface that uses a pressure-sensitive multi-state button. If the button is pushed with a first pressure a preview is provided of the effect that will be produced if the button is pressed using a higher pressure.

There remains a need for a simple user interface that enables a user to conveniently return to a previously-selected photography mode without adding the cost of additional buttons or the inconvenience of needing to navigate complex user-interface menus.

### SUMMARY OF THE INVENTION

The present invention represents a digital camera having a plurality of photography modes, comprising:

an imaging sensor;

an optical system for imaging a scene onto the imaging sensor;

an image capture control for initiating an image capture operation;

a photography mode user interface for selecting between a plurality of photography modes, the photography modes having associated image capture and image processing settings;

a power control for turning the digital camera on or off, wherein when the camera is in an off state and the power control is activated with a first activation pattern the digital camera is turned on and set to operate in a default photography mode and when the power control is activated with a second activation pattern the digital camera is turned on and set to operate in a previously selected photography mode.

The present invention has the advantage that it simplifies camera operation by allowing a user to conveniently return to a previously selected photography mode when the digital camera is powered on. In this way a single button activation can be used to perform two different tasks: turning on the camera and selecting between the previously selected photography mode and a default photography mode.

It has the additional advantage that the user can select between different photography modes with a single button activation without needing to interact with a multi-step menu selection process. This reduces the required number of user inputs required to select the photography mode.

It has the further advantage that no additional user interface controls are required to provide the added functionality.

### BRIEF DESCRIPTION OF THE DRAWINGS

FIG. 1 is a high-level diagram showing the components of a system for classifying digital image according to an embodiment of the present invention;

FIG. 2 is a flow diagram depicting typical image processing operations used to process digital images in a digital camera;

FIGS. 3 and 4 are flowcharts illustrating a method for selecting a photography mode in a digital camera using a short or long button press according to an embodiment of the present invention;

FIGS. 5 and 6 are flowcharts illustrating a method for selecting a photography mode in a digital camera using a single or double button press according to an alternate embodiment of the present invention;

FIGS. 7 and 8 are flowcharts illustrating a method for selecting a photography mode in a digital camera using a light or heavy button pressure according to an alternate embodiment of the present invention; and

FIG. 9 is a flowchart illustrating a method for selecting a photography mode in a digital camera using different activation patterns for a photography mode user interface control according to an alternate embodiment of the present invention.

### DETAILED DESCRIPTION OF THE INVENTION

In the following description, a preferred embodiment of the present invention will be described in terms that would ordinarily be implemented as a software program. Those skilled in the art will readily recognize that the equivalent of such software can also be constructed in hardware. Because image manipulation algorithms and systems are well known, the present description will be directed in particular to algorithms and systems forming part of, or cooperating more directly with, the system and method in accordance with the present invention. Other aspects of such algorithms and systems, and hardware or software for producing and otherwise processing the image signals involved therewith, not specifically shown or described herein, can be selected from such systems, algorithms, components and elements known in the art. Given the system as described according to the invention in the following materials, software not specifically shown, suggested or described herein that is useful for implementation of the invention is conventional and within the ordinary skill in such arts.

Still further, as used herein, a computer program for performing the method of the present invention can be stored in a computer readable storage medium, which can include, for example; magnetic storage media such as a magnetic disk (such as a hard drive or a floppy disk) or magnetic tape; optical storage media such as an optical disc, optical tape, or machine readable bar code; solid state electronic storage devices such as random access memory (RAM), or read only memory (ROM); or any other physical device or medium employed to store a computer program having instructions for controlling one or more computers to practice the method according to the present invention.

The invention is inclusive of combinations of the embodiments described herein. References to “a particular embodiment” and the like refer to features that are present in at least one embodiment of the invention. Separate references to “an embodiment” or “particular embodiments” or the like do not necessarily refer to the same embodiment or embodiments; however, such embodiments are not mutually exclusive, unless so indicated or as are readily apparent to one of skill in the art. The use of singular or plural in referring to the “method” or “methods” and the like is not limiting. It should be noted that, unless otherwise explicitly noted or required by context, the word “or” is used in this disclosure in a non-exclusive sense.

Because digital cameras employing imaging devices and related circuitry for signal capture and processing, and display are well known, the present description will be directed in particular to elements forming part of, or cooperating more directly with, the method and apparatus in accordance with the present invention. Elements not specifically shown or described herein are selected from those known in the art. Certain aspects of the embodiments to be described are provided in software. Given the system as shown and described according to the invention in the following materials, software not specifically shown, described or suggested herein that is useful for implementation of the invention is conventional and within the ordinary skill in such arts.

The following description of a digital camera will be familiar to one skilled in the art. It will be obvious that there are many variations of this embodiment that are possible and are selected to reduce the cost, add features or improve the performance of the camera.

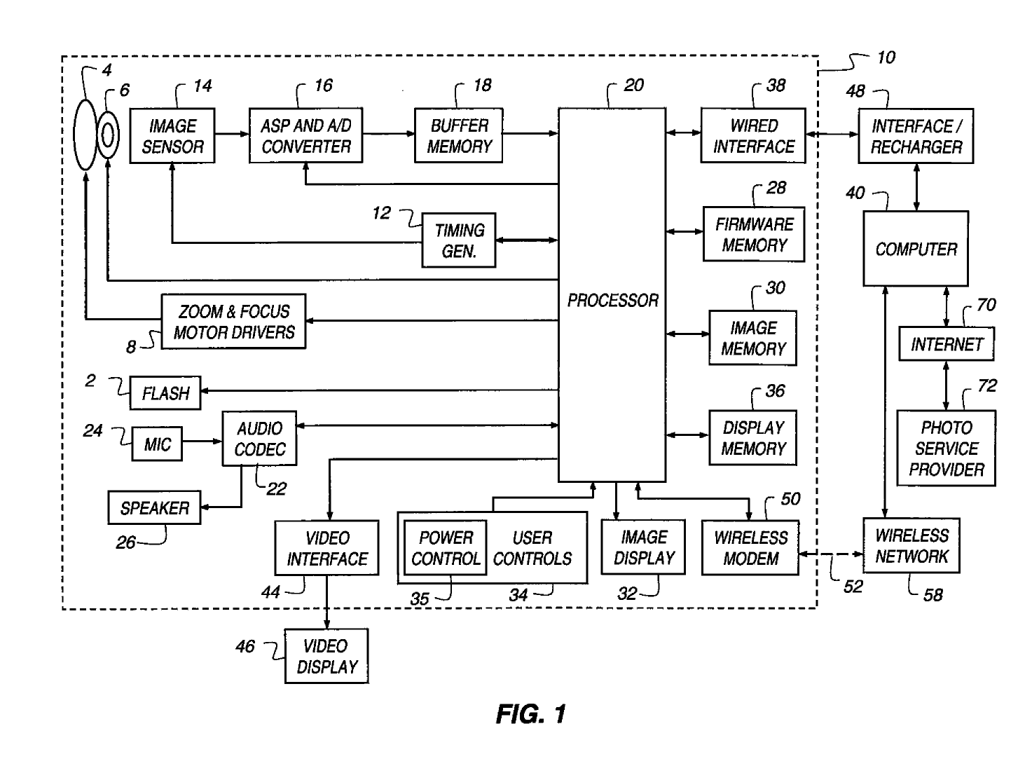

FIG. 1 depicts a block diagram of a digital photography system, including a digital camera 10 in accordance with the present invention. Preferably, the digital camera 10 is a portable battery operated device, small enough to be easily handheld by a user when capturing and reviewing images. The digital camera 10 produces digital images that are stored as digital image files using image memory 30. The phrase “digital image” or “digital image file”, as used herein, refers to any digital image file, such as a digital still image or a digital video file.

In some embodiments, the digital camera 10 captures both motion video images and still images. The digital camera 10 can also include other functions, including, but not limited to, the functions of a digital music player (e.g. an MP3 player), a mobile telephone, a GPS receiver, or a programmable digital assistant (PDA).

The digital camera 10 includes a lens 4 having an adjustable aperture and adjustable shutter 6. In a preferred embodiment, the lens 4 is a zoom lens and is controlled by zoom and focus motor drives 8. The lens 4 focuses light from a scene (not shown) onto an image sensor 14, for example, a single-chip color CCD or CMOS image sensor. The lens 4 is one type optical system for forming an image of the scene on the image sensor 14. In other embodiments, the optical system may use a fixed focal length lens with either variable or fixed focus.

The output of the image sensor 14 is converted to digital form by Analog Signal Processor (ASP) and Analog-to-Digital (A/D) converter 16, and temporarily stored in buffer memory 18. The image data stored in buffer memory 18 is subsequently manipulated by a processor 20, using embedded software programs (e.g. firmware) stored in firmware memory 28. In some embodiments, the software program is permanently stored in firmware memory 28 using a read only memory (ROM). In other embodiments, the firmware memory 28 can be modified by using, for example, Flash EPROM memory. In such embodiments, an external device can update the software programs stored in firmware memory 28 using the wired interface 38 or the wireless modem 50. In such embodiments, the firmware memory 28 can also be used to store image sensor calibration data, user setting selections and other data which must be preserved when the camera is turned off. In some embodiments, the processor 20 includes a program memory (not shown), and the software programs stored in the firmware memory 28 are copied into the program memory before being executed by the processor 20.

It will be understood that the functions of processor 20 can be provided using a single programmable processor or by using multiple programmable processors, including one or more digital signal processor (DSP) devices. Alternatively, the processor 20 can be provided by custom circuitry (e.g., by one or more custom integrated circuits (ICs) designed specifically for use in digital cameras), or by a combination of programmable processor(s) and custom circuits. It will be understood that connectors between the processor 20 from some or all of the various components shown in FIG. 1 can be made using a common data bus. For example, in some embodiments the connection between the processor 20, the buffer memory 18, the image memory 30, and the firmware memory 28 can be made using a common data bus.

The processed images are then stored using the image memory 30. It is understood that the image memory 30 can be any form of memory known to those skilled in the art including, but not limited to, a removable Flash memory card, internal Flash memory chips, magnetic memory, or optical memory. In some embodiments, the image memory 30 can include both internal Flash memory chips and a standard interface to a removable Flash memory card, such as a Secure Digital (SD) card. Alternatively, a different memory card format can be used, such as a micro SD card, Compact Flash (CF) card, MultiMedia Card (MMC), xD card or Memory Stick.

The image sensor 14 is controlled by a timing generator 12, which produces various clocking signals to select rows and pixels and synchronizes the operation of the ASP and A/D converter 16. The image sensor 14 can have, for example, 12.4 megapixels (4088×3040 pixels) in order to provide a still image file of approximately 4000×3000 pixels. To provide a color image, the image sensor is generally overlaid with a color filter array, which provides an image sensor having an array of pixels that include different colored pixels. The different color pixels can be arranged in many different patterns. As one example, the different color pixels can be arranged using the well-known Bayer color filter array, as described in commonly assigned U.S. Pat. No. 3,971,065, “Color imaging array” to Bayer, the disclosure of which is incorporated herein by reference. As a second example, the different color pixels can be arranged as described in commonly assigned U.S. Patent Application Publication 2007/0024931 to Compton and Hamilton, entitled “Image sensor with improved light sensitivity”, the disclosure of which is incorporated herein by reference. These examples are not limiting, and many other color patterns may be used.

It will be understood that the image sensor 14, timing generator 12, and ASP and A/D converter 16 can be separately fabricated integrated circuits, or they can be fabricated as a single integrated circuit as is commonly done with CMOS image sensors. In some embodiments, this single integrated circuit can perform some of the other functions shown in FIG. 1, including some of the functions provided by processor 20.

The image sensor 14 is effective when actuated in a first mode by timing generator 12 for providing a motion sequence of lower resolution sensor image data, which is used when capturing video images and also when previewing a still image to be captured, in order to compose the image. This preview mode sensor image data can be provided as HD resolution image data, for example, with 1280×720 pixels, or as VGA resolution image data, for example, with 640×480 pixels, or using other resolutions which have significantly fewer columns and rows of data, compared to the resolution of the image sensor.

The preview mode sensor image data can be provided by combining values of adjacent pixels having the same color, or by eliminating some of the pixels values, or by combining some color pixels values while eliminating other color pixel values. The preview mode image data can be processed as described in commonly assigned U.S. Pat. No. 6,292,218 to Parulski, et al., entitled “Electronic camera for initiating capture of still images while previewing motion images,” which is incorporated herein by reference.

The image sensor 14 is also effective when actuated in a second mode by timing generator 12 for providing high resolution still image data. This final mode sensor image data is provided as high resolution output image data, which for scenes having a high illumination level includes all of the pixels of the image sensor, and can be, for example, a 12 megapixel final image data having 4000×3000 pixels. At lower illumination levels, the final sensor image data can be provided by “binning” some number of like-colored pixels on the image sensor, in order to increase the signal level and thus the “ISO speed” of the sensor.

The zoom and focus motor drivers 8 are controlled by control signals supplied by the processor 20, to provide the appropriate focal length setting and to focus the scene onto the image sensor 14. The exposure level of the image sensor 14 is controlled by controlling the f/number and exposure time of the adjustable aperture and adjustable shutter 6, the exposure period of the image sensor 14 via the timing generator 12, and the gain (i.e., ISO speed) setting of the ASP and A/D converter 16. The processor 20 also controls a flash 2 which can illuminate the scene.

The lens 4 of the digital camera 10 can be focused in the first mode by using “through-the-lens” autofocus, as described in commonly-assigned U.S. Pat. No. 5,668,597, entitled “Electronic Camera with Rapid Automatic Focus of an Image upon a Progressive Scan Image Sensor” to Parulski et al., which is incorporated herein by reference. This is accomplished by using the zoom and focus motor drivers 8 to adjust the focus position of the lens 4 to a number of positions ranging between a near focus position to an infinity focus position, while the processor 20 determines the closest focus position which provides a peak sharpness value for a central portion of the image captured by the image sensor 14. The focus distance which corresponds to the closest focus position can then be utilized for several purposes, such as automatically setting an appropriate scene mode, and can be stored as metadata in the image file, along with other lens and camera settings.

The processor 20 produces menus and low resolution color images that are temporarily stored in display memory 36 and are displayed on the image display 32. The image display 32 is typically an active matrix color liquid crystal display (LCD), although other types of displays, such as organic light emitting diode (OLED) displays, can be used. A video interface 44 provides a video output signal from the digital camera 10 to a video display 46, such as a flat panel HDTV display. In preview mode, or video mode, the digital image data from buffer memory 18 is manipulated by processor 20 to form a series of motion preview images that are displayed, typically as color images, on the image display 32. In review mode, the images displayed on the image display 32 are produced using the image data from the digital image files stored in image memory 30.

The graphical user interface displayed on the image display 32 is controlled in response to user input provided by user controls 34. The user controls 34 are used to select various camera modes, such as video capture mode, still capture mode, and review mode, and to initiate capture of still images and recording of motion images. User controls 34 typically include some combination of buttons, rocker switches, joysticks, or rotary dials. In some embodiments, some of the user controls 34 are provided by using a touch screen overlay on the image display 32. In other embodiments, additional status displays or images displays can be used. In a preferred embodiment, the user controls 34 include a power control 35 (e.g., a power button) which is used to turn on or off the camera, as well as other controls such as a lens controls to control the lens 4, and an image capture control (e.g., a shutter button) to initiate an image capture operation. In some embodiments, the still preview mode is initiated when the user partially depresses the shutter button, and the still image capture mode is initiated when the user fully depresses the shutter button.

The camera modes that can be selected using the user controls 34 include a “timer” mode. When the “timer” mode is selected, a short delay (e.g., 10 seconds) occurs after the user fully presses the shutter button, before the processor 20 initiates the capture of a still image.

An audio codec 22 connected to the processor 20 receives an audio signal from a microphone 24 and provides an audio signal to a speaker 26. These components can be to record and playback an audio track, along with a video sequence or still image. If the digital camera 10 is a multi-function device such as a combination camera and mobile phone, the microphone 24 and the speaker 26 can be used for telephone conversation.

In some embodiments, the speaker 26 can be used as part of the user interface, for example to provide various audible signals which indicate that a user control has been depressed, or that a particular mode has been selected. In some embodiments, the microphone 24, the audio codec 22, and the processor 20 can be used to provide voice recognition, so that the user can provide a user input to the processor 20 by using voice commands, rather than user controls 34. The speaker 26 can also be used to inform the user of an incoming phone call. This can be done using a standard ring tone stored in firmware memory 28, or by using a custom ring-tone downloaded from a wireless network 58 and stored in the image memory 30. In addition, a vibration device (not shown) can be used to provide a silent (e.g., non audible) notification of an incoming phone call.

The processor 20 also provides additional processing of the image data from the image sensor 14, in order to produce rendered sRGB image data which is compressed and stored within a “finished” image file, such as a well-known Exif-JPEG image file, in the image memory 30.

The digital camera 10 can be connected via the wired interface 38 to an interface/recharger 48, which is connected to a computer 40, which can be a desktop computer or portable computer located in a home or office. The wired interface 38 can conform to, for example, the well-known USB 2.0 interface specification. The interface/recharger 48 can provide power via the wired interface 38 to a set of rechargeable batteries (not shown) in the digital camera 10.

The digital camera 10 can include a wireless modem 50, which interfaces over a radio frequency band 52 with the wireless network 58. The wireless modem 50 can use various wireless interface protocols, such as the well-known Bluetooth wireless interface or the well-known 802.11 wireless interface. The computer 40 can upload images via the Internet 70 to a photo service provider 72, such as the Kodak EasyShare Gallery. Other devices (not shown) can access the images stored by the photo service provider 72.

In alternative embodiments, the wireless modem 50 communicates over a radio frequency (e.g. wireless) link with a mobile phone network (not shown), such as a 3GSM network, which connects with the Internet 70 in order to upload digital image files from the digital camera 10. These digital image files can be provided to the computer 40 or the photo service provider 72.

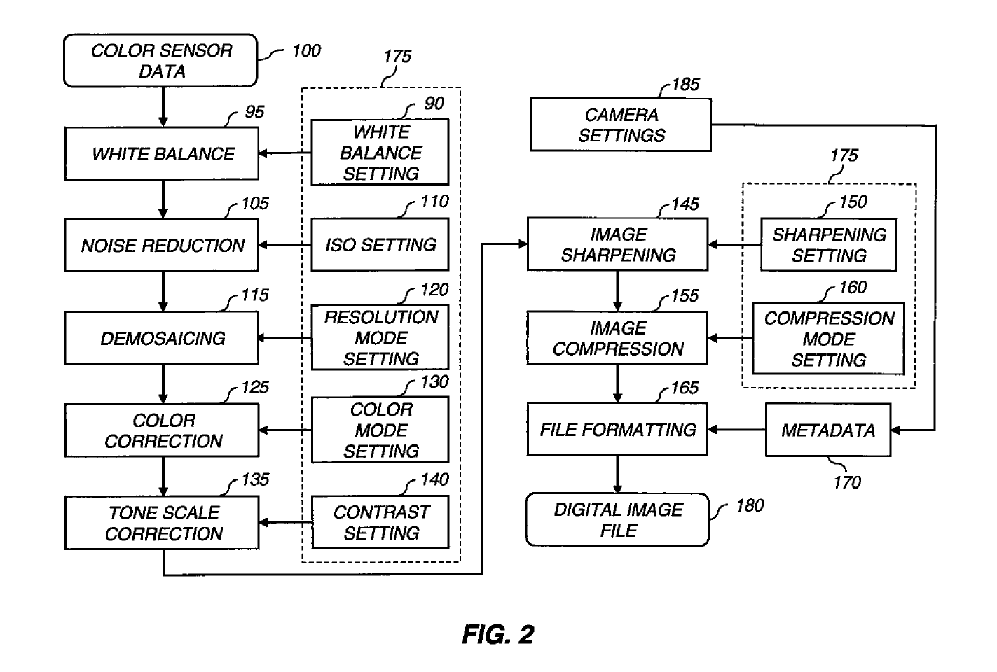

FIG. 2 is a flow diagram depicting image processing operations that can be performed by the processor 20 in the digital camera 10 (FIG. 1) in order to process color sensor data 100 from the image sensor 14 output by the ASP and A/D converter 16. In some embodiments, the processing parameters used by the processor 20 to manipulate the color sensor data 100 for a particular digital image are determined by various user settings 175, which can be selected via the user controls 34 in response to menus displayed on the image display 32.

The color sensor data 100 which has been digitally converted by the ASP and A/D converter 16 is manipulated by a white balance step 95. In some embodiments, this processing can be performed using the methods described in commonly-assigned U.S. Pat. No. 7,542,077 to Miki, entitled “White balance adjustment device and color identification device”, the disclosure of which is herein incorporated by reference. The white balance can be adjusted in response to a white balance setting 90, which can be manually set by a user, or which can be automatically set by the camera.

The color image data is then manipulated by a noise reduction step 105 in order to reduce noise from the image sensor 14. In some embodiments, this processing can be performed using the methods described in commonly-assigned U.S. Pat. No. 6,934,056 to Gindele et al., entitled “Noise cleaning and interpolating sparsely populated color digital image using a variable noise cleaning kernel,” the disclosure of which is herein incorporated by reference. The level of noise reduction can be adjusted in response to an ISO setting 110, so that more filtering is performed at higher ISO exposure index setting.

The color image data is then manipulated by a demosaicing step 115, in order to provide red, green and blue (RGB) image data values at each pixel location. Algorithms for performing the demosaicing step 115 are commonly known as color filter array (CFA) interpolation algorithms or “deBayering” algorithms. In one embodiment of the present invention, the demosaicing step 115 can use the luminance CFA interpolation method described in commonly-assigned U.S. Pat. No. 5,652,621, entitled “Adaptive color plane interpolation in single sensor color electronic camera,” to Adams et al., the disclosure of which is incorporated herein by reference. The demosaicing step 115 can also use the chrominance CFA interpolation method described in commonly-assigned U.S. Pat. No. 4,642,678, entitled “Signal processing method and apparatus for producing interpolated chrominance values in a sampled color image signal”, to Cok, the disclosure of which is herein incorporated by reference.

In some embodiments, the user can select between different pixel resolution modes, so that the digital camera can produce a smaller size image file. Multiple pixel resolutions can be provided as described in commonly-assigned U.S. Pat. No. 5,493,335, entitled “Single sensor color camera with user selectable image record size,” to Parulski et al., the disclosure of which is herein incorporated by reference. In some embodiments, a resolution mode setting 120 can be selected by the user to be full size (e.g. 3,000×2,000 pixels), medium size (e.g. 1,500×1000 pixels) or small size (750×500 pixels).

The color image data is color corrected in color correction step 125. In some embodiments, the color correction is provided using a 3×3 linear space color correction matrix, as described in commonly-assigned U.S. Pat. No. 5,189,511, entitled “Method and apparatus for improving the color rendition of hardcopy images from electronic cameras” to Parulski, et al., the disclosure of which is incorporated herein by reference. In some embodiments, different user-selectable color modes can be provided by storing different color matrix coefficients in firmware memory 28 of the digital camera 10. For example, four different color modes can be provided, so that the color mode setting 130 is used to select one of the following color correction matrices:

### Setting 1 (Normal Color Reproduction)

$$[ \begin{matrix}{R}_{out} \\ {G}_{out} \\ {B}_{out}\end{matrix} ] = [ \begin{matrix}1.50 & - 0.30 & - 0.20 \\ - 0.40 & 1.80 & - 0.40 \\ - 0.20 & - 0.20 & 1.40\end{matrix} ] [ \begin{matrix}{R}_{in} \\ {G}_{in} \\ {B}_{in}\end{matrix} ] \qquad ( 1 )$$

### Setting 2 (Saturated Color Reproduction

$$[ \begin{matrix}{R}_{out} \\ {G}_{out} \\ {B}_{out}\end{matrix} ] = [ \begin{matrix}2.00 & - 0.60 & - 0.40 \\ - 0.80 & 2.60 & - 0.80 \\ - 0.40 & - 0.40 & 1.80\end{matrix} ] [ \begin{matrix}{R}_{in} \\ {G}_{in} \\ {B}_{in}\end{matrix} ] \qquad ( 2 )$$

### Setting 3 (De-Saturated Color Reproduction)

$$[ \begin{matrix}{R}_{out} \\ {G}_{out} \\ {B}_{out}\end{matrix} ] = [ \begin{matrix}1.25 & - 0.15 & - 0.10 \\ - 0.20 & 1.40 & - 0.20 \\ - 0.10 & - 0.10 & 1.20\end{matrix} ] [ \begin{matrix}{R}_{in} \\ {G}_{in} \\ {B}_{in}\end{matrix} ] \qquad ( 3 )$$

### Setting 4 (Monochrome)

$$[ \begin{matrix}{R}_{out} \\ {G}_{out} \\ {B}_{out}\end{matrix} ] = [ \begin{matrix}0.30 & 0.60 & 0.10 \\ 0.30 & 0.60 & 0.10 \\ 0.30 & 0.60 & 0.10\end{matrix} ] [ \begin{matrix}{R}_{in} \\ {G}_{in} \\ {B}_{in}\end{matrix} ] \qquad ( 4 )$$

In other embodiments, a three-dimensional lookup table can be used to perform the color correction step 125.

The color image data is also manipulated by a tone scale correction step 135. In some embodiments, the tone scale correction step 135 can be performed using a one-dimensional look-up table as described in U.S. Pat. No. 5,189,511, cited earlier. In some embodiments, a plurality of tone scale correction look-up tables is stored in the firmware memory 28 in the digital camera 10. These can include look-up tables which provide a “normal” tone scale correction curve, a “high contrast” tone scale correction curve, and a “low contrast” tone scale correction curve. A user selected contrast setting 140 is used by the processor 20 to determine which of the tone scale correction look-up tables to use when performing the tone scale correction step 135.

The color image data is also manipulated by an image sharpening step 145. In some embodiments, this can be provided using the methods described in commonly-assigned U.S. Pat. No. 6,192,162 entitled “Edge enhancing colored digital images” to Hamilton, et al., the disclosure of which is incorporated herein by reference. In some embodiments, the user can select between various sharpening settings, including a “normal sharpness” setting, a “high sharpness” setting, and a “low sharpness” setting. In this example, the processor 20 uses one of three different edge boost multiplier values, for example 2.0 for “high sharpness”, 1.0 for “normal sharpness”, and 0.5 for “low sharpness” levels, responsive to a sharpening setting 150 selected by the user of the digital camera 10.

The color image data is also manipulated by an image compression step 155. In some embodiments, the image compression step 155 can be provided using the methods described in commonly-assigned U.S. Pat. No. 4,774,574, entitled “Adaptive block transform image coding method and apparatus” to Daly et al., the disclosure of which is incorporated herein by reference. In some embodiments, the user can select between various compression settings. This can be implemented by storing a plurality of quantization tables, for example, three different tables, in the firmware memory 28 of the digital camera 10. These tables provide different quality levels and average file sizes for the compressed digital image file 180 to be stored in the image memory 30 of the digital camera 10. A user selected compression mode setting 160 is used by the processor 20 to select the particular quantization table to be used for the image compression step 155 for a particular image.

The compressed color image data is stored in a digital image file 180 using a file formatting step 165. The image file can include various metadata 170. Metadata 170 is any type of information that relates to the digital image, such as the model of the camera that captured the image, the size of the image, the date and time the image was captured, and various camera settings, such as the lens focal length, the exposure time and f-number of the lens, and whether or not the camera flash fired. In a preferred embodiment, all of this metadata 170 is stored using standardized tags within the well-known Exif-JPEG still image file format. In a preferred embodiment of the present invention, the metadata 170 includes information about camera settings 185.

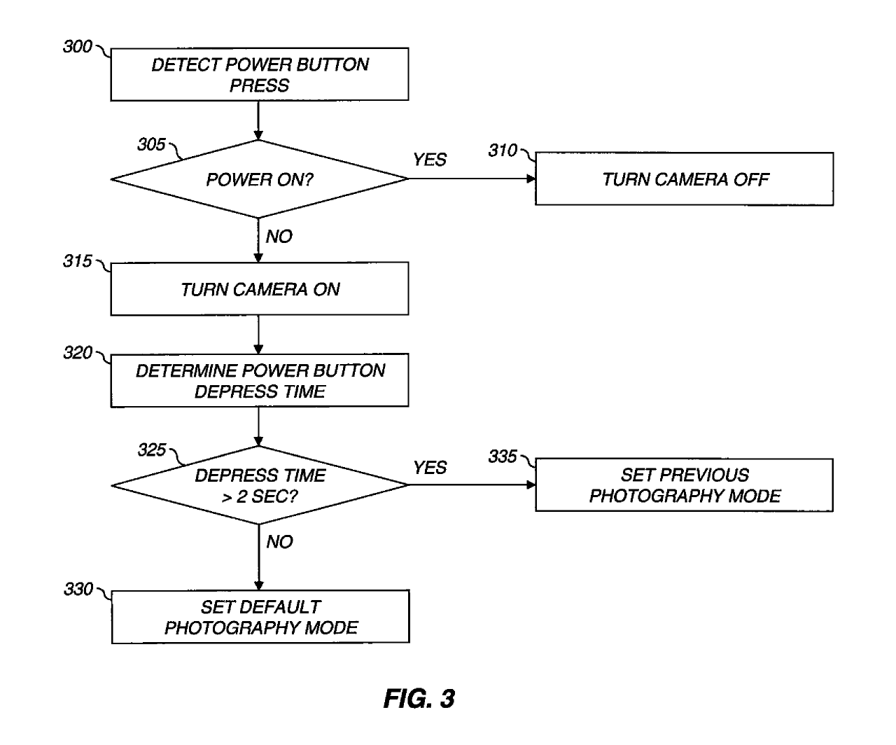

The present invention will now be described with reference to FIG. 3, which is a flowchart illustrating a method for using the power control 35 (FIG. 1) on a digital camera 10 (FIG. 1) to select a photography mode according to an embodiment of the present invention. In FIG. 3, a detect power button press step 300 detects a press of the power control 35 (FIG. 1). A power on test 305 checks whether the power is already on and makes a decision. If the power is already on, a turn camera off step 310 is executed, turning the camera power off. (Note that when the digital camera 10 (FIG. 1) is in the power off mode, the digital camera 10 may not be totally powered down, but may be in a sleep mode which uses a minimal level of power consumption.) If the power on test 305 determines that the power is not already on, the process continues to a turn camera on step 315, turning the camera power on. A process is then initiated which detects an activation pattern for the power control 35. In this embodiment, a determine power button depress time step 320 is used to determine a power button depress time. A depress time test 325 checks whether the power button depress time exceeds a predetermined threshold, in this case 2 seconds. If the power button depress time is shorter than the predetermined threshold, a set default photography mode step 330 is executed, setting the digital camera 10 to operate in a default photography mode. Otherwise, if the power button depress time is longer than the predetermined threshold, a set previous photography mode step 335 is executed, setting the digital camera 10 to operate in a previously selected photography mode. In this way a single button activation can be used to perform two different tasks: turning on the camera and selecting between the previously selected photography mode and a default photography mode.

Digital cameras typically provide a variety of photography modes that the user can select from according to the photography conditions and their personal preferences. A wide variety photography modes are known in the art. Examples of typical photography modes include smart capture, portrait, sport, landscape, close-up, sunset, backlight, children, bright, self-portrait, night portrait, night landscape, high-ISO, panorama, color boost, grayscale, sepia tone, aperture priority and shutter priority. Typically the photography mode can be selected using interactive menus provided as part of the user controls 34. Often it may be necessary to navigate through several levels of menus in order to select a particular photography mode.

In a preferred embodiment, the default photography mode selected by the set default photography mode step 330 is an automatic mode which is designed to produce good results under a wide variety of photography conditions. Such automatic modes go by a variety different names such as “auto mode,” “default mode,” “smart capture mode” or “program mode.” In this automatic mode, the digital camera 10 typically analyzes the photography conditions to automatically determine various image capture settings such as the exposure index, the lens F/#, the exposure time and the electronic flash setting, as well as other user settings 175, such as those discussed with reference to FIG. 2. In other embodiments, some other photography mode can be used as the default photography mode. In some embodiments, the user can be allowed to designate a preferred photography mode to be the default photography mode.

In a preferred embodiment, the previously selected photography mode set by the set previous photography mode step 335 is the photography mode in which the digital camera 10 was set to operate at the time that the digital camera 10 was last powered off. For example, if a user is capturing images at a soccer game, they would typically set the camera to operate in a sport photography mode. The sport photography mode would generally choose appropriate image capture settings to minimize the motion blur associated with moving subjects. The user may then choose to power down the digital camera 10 to save the battery life (or the digital camera 10 may automatically power itself down after a period of inactivity). If the user then desires to resume capturing additional images at the soccer game, they would typically desire to power the camera back on directly into the sport photography mode rather than the default photography mode in order to save the trouble of navigating through the various user control menus to select the appropriate photography mode. According to the method of the present invention, this can be done by activating the power control 35 according to a defined activation pattern. In the example of FIG. 3, the activation pattern to select the previously selected photography mode would be a long button press.

In other embodiments the previously selected photography mode selected by the set previous photography mode step 335 may not necessarily be the most recently selected photography mode. In some embodiments, provision can be made for the user to designate a particular photography mode to be a favorite photography mode that is selected when the power control 35 is activated according the defined activation pattern. For example, if a user frequently desired to set the camera to operate in a portrait photography mode, a user interface can be provided that enables to user to select this particular photography mode as their preferred photography mode. When the digital camera 10 is then powered on using a long button press, the digital camera 10 would automatically be set to operate in the portrait photography mode.

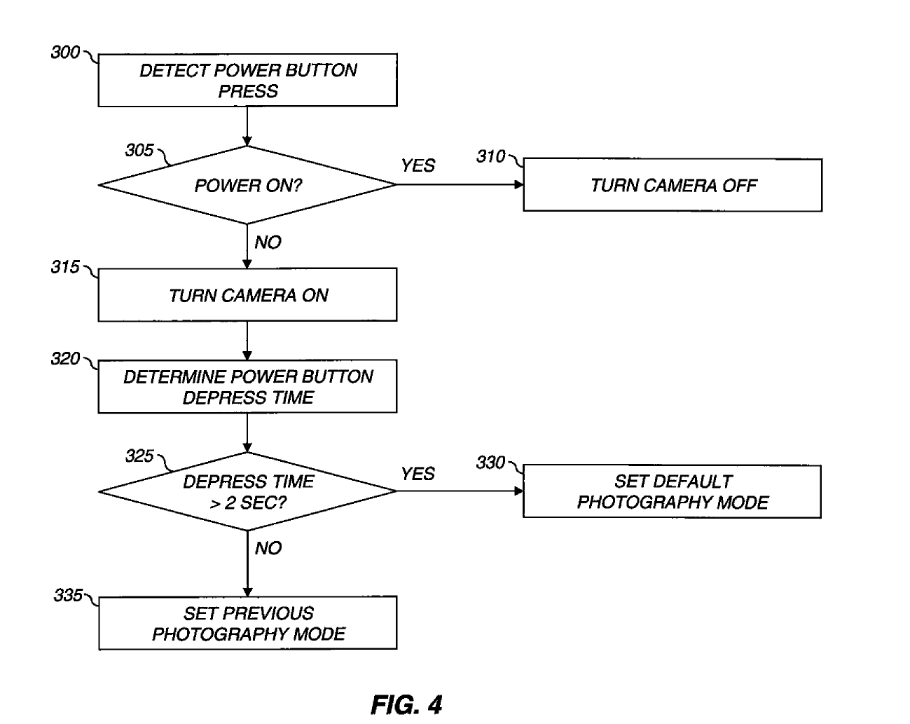

In an alternate embodiment of the present invention, the behavior or the power control 35 can be reversed relative to that shown in FIG. 3 so that a long button press is used to select the default photography mode rather than the previously selected photography mode. This configuration is illustrated in FIG. 4, which is identical to FIG. 3 except that the positions of the set default photography mode step 330 and the set previous photography mode step 335 are reversed. In this embodiment, if the depress time exceeds the predetermined threshold (e.g., 2 seconds), the set default photography mode step 330 is executed, setting the digital camera to operate in the default photography mode. Otherwise, if the depress time is less than the predetermined threshold, the set previous photography mode step 335 is executed, setting the digital camera to operate in the previously selected photography mode.

In other embodiments, more than two different photography modes can be defining different ranges of depress times for each of the photography modes. For example, if the depress time is less than 2 seconds, the digital camera 10 can be set to operate in the default photography mode; if the depress time is between 2 seconds and 4 seconds the digital camera 10 can be set to operate in the most recently used photography mode; and if the depress time is more than 4 seconds the digital camera 10 can be set to operate in a designated favorite photography mode.

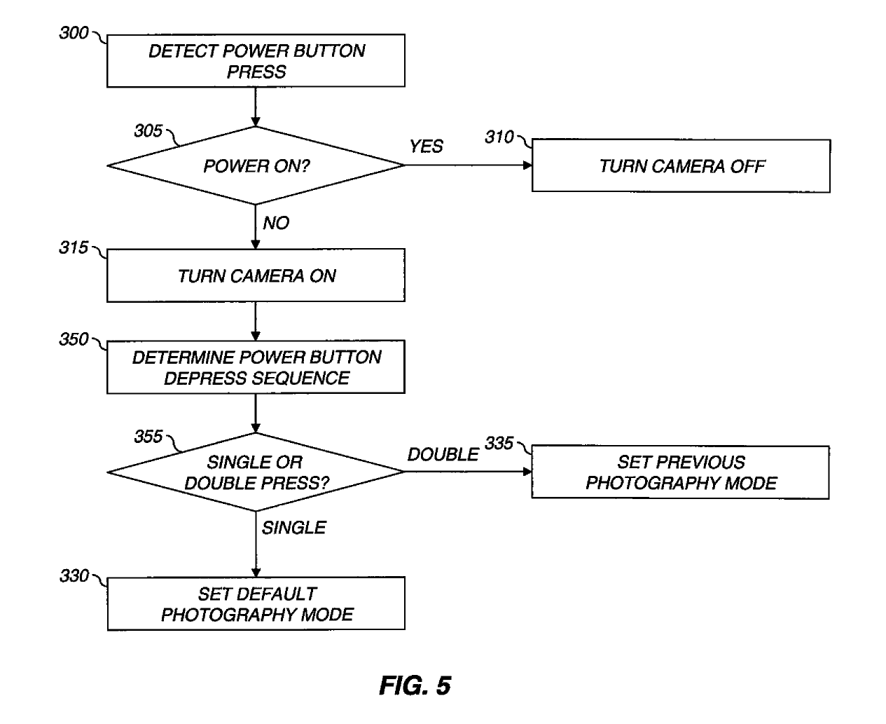

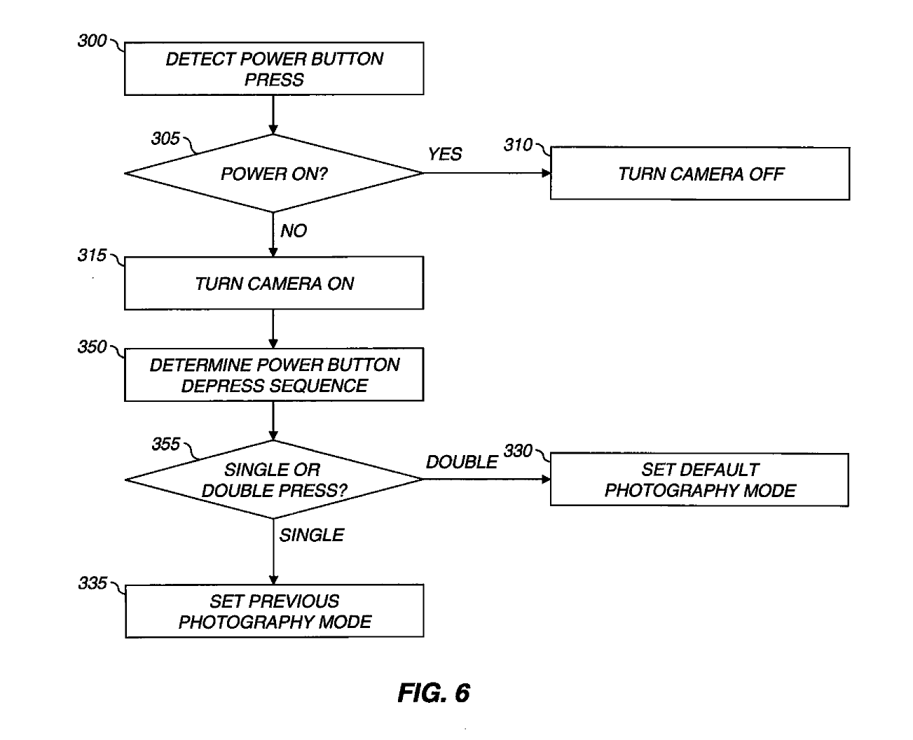

In alternate embodiments of the present invention, other types of activation patterns can be used rather than the different button depress time configurations discussed relative to FIGS. 3 and 4. For example, FIGS. 5 and 6 illustrate embodiments where the activation pattern is characterized by a number of button presses. In these configurations, the determine power button depress time step 320 is replaced by a determine power button depress sequence step 350, and the depress time test 325 is replaced by a single or double press test 355. The determine power button depress sequence step 350 determines a power button depress sequence. In some embodiments, the power button depress sequence is characterized by a number of button presses (e.g., a single press or a double press). The single or double press test 355 checks the power button depress sequence to determine whether a single press or double press was executed. If the power button depress sequence was a single press then the set default photography mode step 330 is executed, setting the camera to operate in the default photography mode. Otherwise, if the power button depress sequence was a double press then the set previous photography mode step 335 is executed, setting the camera to operate in the previously selected photography mode.

In the configuration of FIG. 6, the behavior or the power control 35 is reversed relative to that shown in FIG. 5 so that a double button press is used to select the default photography mode rather than the previously selected photography mode. In this embodiment, if the power button depress sequence was a double press, the set default photography mode step 330 is executed, setting the digital camera to operate in the default photography mode. Otherwise, if the power button depress sequence was a single press, the set previous photography mode step 335 is executed, setting the digital camera to operate in the previously selected photography mode.

In some embodiments of the present invention, the power control 35 is a pressure-sensitive button, or some other form of touch-sensitive surface. There are a variety of different types of pressure-sensitive buttons. Some pressure-sensitive buttons are spring-loaded mechanical buttons that depress to different positions depending on the depress pressure. When the button is depressed with a light pressure, the button depresses to a first position and gives a first signal (S1); and when the button is depressed with a heavy pressure, the button depresses to a second position and gives a second signal (S2). Other types of pressure-sensitive buttons use electronic pressure sensors which produce a variable electrical signal according to the applied pressure. There are a variety of different electronic pressure sensors known in the art, including piezoresistive pressure sensors, piezoelectric pressure sensors, electromagnetic pressure sensors or capacitive pressure sensors.

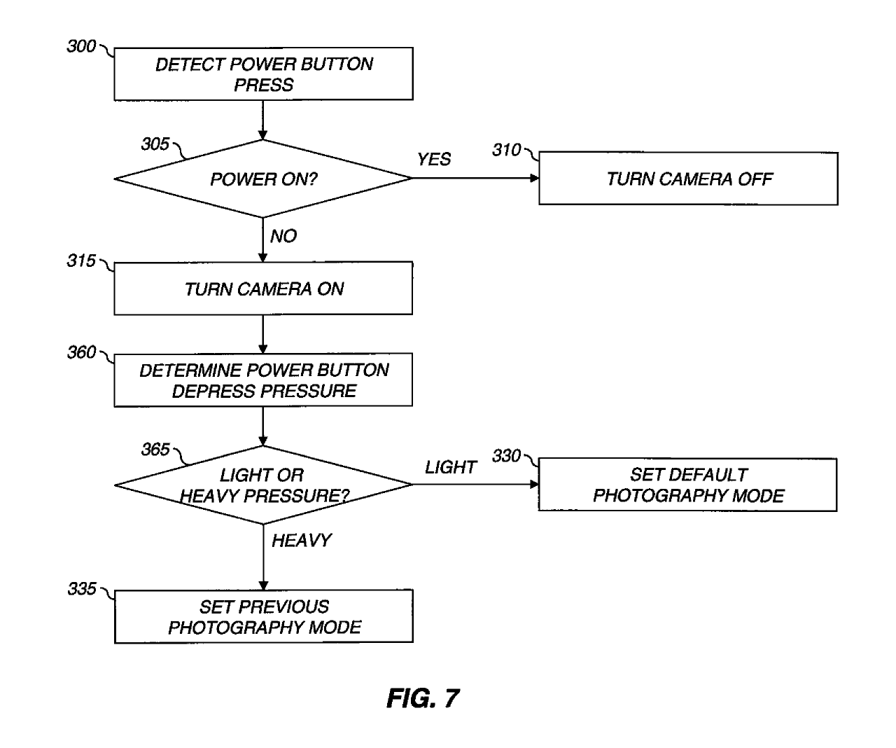

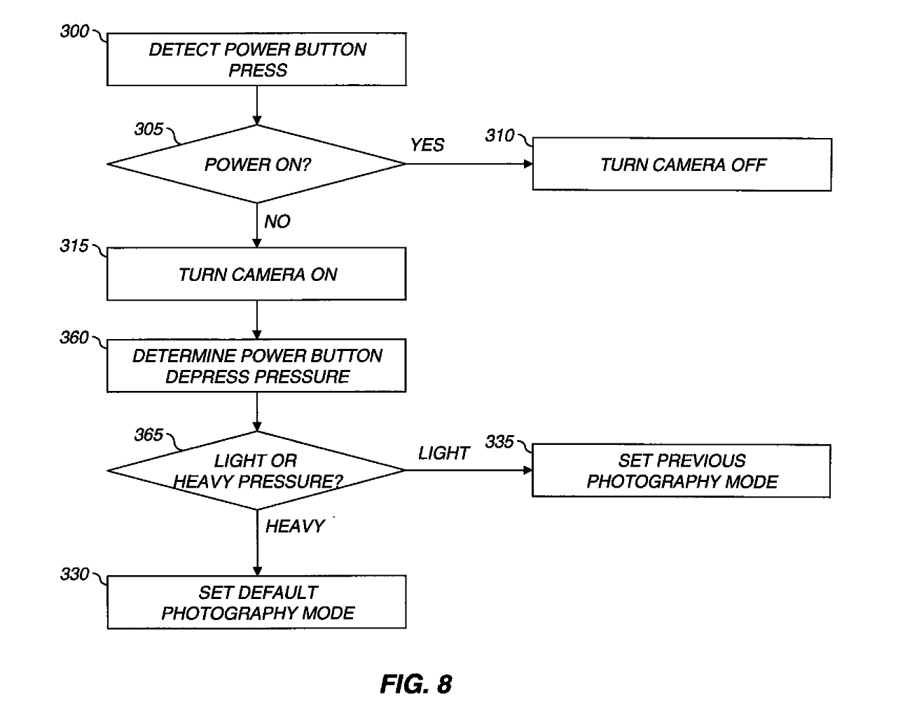

FIGS. 7 and 8 illustrate embodiments of the present invention where the activation pattern is characterized by different button depress pressures. In these configurations, the determine power button depress time step 320 of FIGS. 3 and 4 is replaced by a determine power button depress pressure step 360, and the depress time test 325 is replaced by a light or heavy pressure test 365. The determine power button depress pressure step 360 determines a power button depress pressure. In some embodiments, the power button depress pressure is characterized by a pressure value providing an indication of the pressure used to press on the power control 35. In other embodiments, the power button depress pressure is a discrete value indicating whether the depress pressure was light or heavy. The light or heavy pressure test 365 examines the power button depress pressure to determine whether the depress pressure was light or heavy. For example, if the depress pressure is less than 2 Newtons then the power button depress pressure can be characterized as light, otherwise it can be characterized as heavy.

In the embodiment of FIG. 7, if the depress pressure was light then the set default photography mode step 330 is executed, setting the camera to operate in the default photography mode. Otherwise, if the depress pressure was heavy then the set previous photography mode step 335 is executed, setting the camera to operate in the previously selected photography mode.

In the configuration of FIG. 8, the behavior or the power control 35 is reversed relative to that shown in FIG. 7 so that heavy depress pressure is used to select the default photography mode rather than the previously selected photography mode. In this embodiment, if the depress pressure was heavy, the set default photography mode step 330 is executed setting the digital camera to operate in the default photography mode. Otherwise, if the depress pressure was light, the set previous photography mode step 335 is executed setting the digital camera to operate in the previously selected photography mode.

In some embodiments of the present invention, the user can be allowed to select the activation patterns associated with the default photography mode and one or more previously selected photography modes. For example, a menu can be provided as part of the user controls 34 that allows the user to select between any of the activation patterns described with respect to FIGS. 3-8.

In alternate embodiments of the present invention, a different user control 34 besides the power control 35 is used to select the previously selected photography mode. For example, a photography mode user interface control can be used for this purpose. In some embodiments, the photography mode user interface control is a dedicated photography mode button. In other embodiments, the photography mode user interface control can be an element of a user control menu or can be incorporated into a touch-screen user interface.

According to one embodiment, when the photography mode user interface control is activated with a first activation pattern (e.g., a single button press) the digital camera initiates an interactive photography mode selection process and when the photography mode user interface is activated with a second activation pattern (e.g., a double button press) the digital camera is set to operate in the previously selected photography mode. This has the advantage that the previously selected photography mode can be selected without the user needing to interact with the interactive mode selection process.

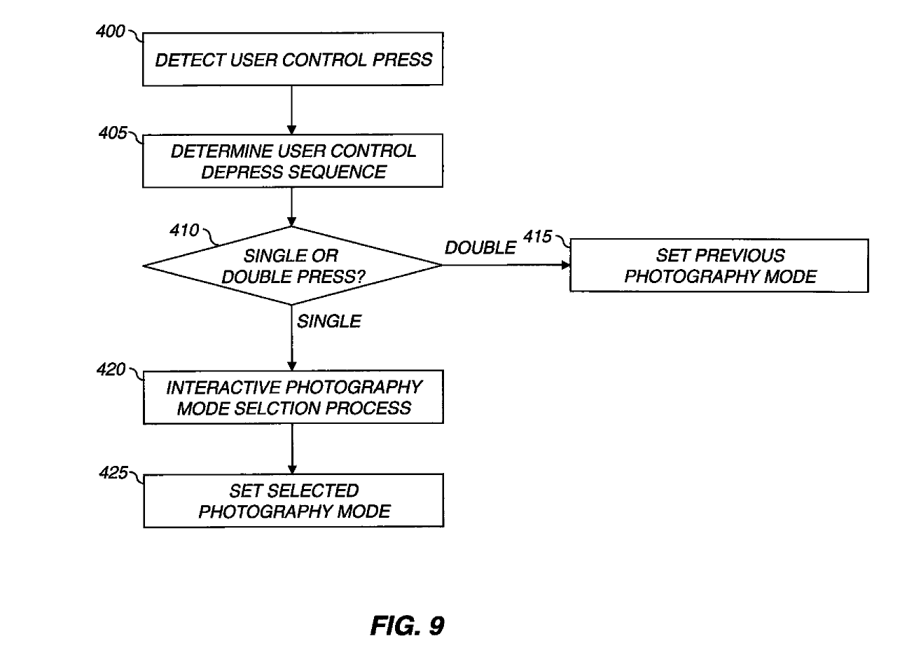

A configuration of this type is illustrated in FIG. 9. A detect user control press step 400 is used to detect that the photography mode user interface control has been pressed. Next, a determine user control depress sequence step 405 is used to detect the activation pattern for the photography mode user interface control. In this example, a single or double press test 410 is used to determine whether the photography mode user interface control was activated using a single press or a double press. If the photography mode user interface control was activated with a double press then a set previous photography mode step 415 is used to set the digital camera 10 to operate in the previously selected photography mode. Otherwise, if the photography mode user interface control was activated with a single press than an interactive photography mode selection process step 420 is executed. In one embodiment, the interactive photography mode selection process step 420 presents the user with a menu of available photography modes. The user then navigates through the menu to select a desired photography mode. The interactive photography mode selection process step 420 can use any user interface control mechanism known in the art. Once the user has selected a desired photography mode, a set selected photography mode step 425 is used to set the digital camera 10 to operated in the selected photography mode. It will be obvious to one skilled in the art that a wide variety of different types of activation patterns can be used to select between the set previous photography mode step 415 and the interactive photography mode selection process step 420, including any of the various activation patterns discussed with reference to FIGS. 3-8.

In some configurations, the previously selected photography mode that is selected using the photography mode user interface control is the photography mode that the digital camera had been in when it was last turned off. In other configurations, the previously selected photography mode is the photography mode that had been selected previous to the currently selected photography mode. This provides a means for users to “undo” the photography mode selection if they are not satisfied with their selection. For example, if the user is capturing images in the smart capture photography mode, he may decide to experiment with a grayscale photography mode. If the user then decides he wants to return to capturing images in the smart capture photography mode he can activate the photography mode user interface control with the appropriate activation pattern (e.g., a double button press), rather than needing to navigate through a series of menus.

In some embodiments, both the power control 35 and the photography mode user interface control can be used to select the previously selected photography mode. This enables the user to return to the previously selected photography mode if they forget to activate the power control 35 with the appropriate activation pattern.

Another means to provide the functionality of the present invention would be to provide an additional user control 34 dedicated to setting the camera to activate in the previously selected photography mode. For example, an additional user interface button could be provided on the back of the digital camera 10. However, the addition of additional user interface controls adds cost and complexity to the design of the digital camera 10. The present invention has the advantage that it allows the user to conveniently return to a previously selected photography mode without requiring the addition of another user interface control.

The invention has been described in detail with particular reference to certain preferred embodiments thereof, but it will be understood that variations and modifications can be effected within the spirit and scope of the invention.

### PARTS LIST

2 flash
4 lens
6 adjustable aperture and adjustable shutter
8 zoom and focus motor drives
10 digital camera
12 timing generator
14 image sensor
16 ASP and A/D Converter
18 buffer memory
20 processor
22 audio codec
24 microphone
26 speaker
28 firmware memory
30 image memory
32 image display
34 user controls
35 power control
36 display memory
48 wired interface
40 computer
44 video interface
46 video display
48 interface/recharger
50 wireless modem
52 radio frequency band
58 wireless network
70 Internet
72 photo service provider
90 white balance setting
95 white balance step
100 color sensor data
105 noise reduction step
110 ISO setting
115 demosaicing step
120 resolution mode setting
125 color correction step
130 color mode setting
135 tone scale correction step
140 contrast setting
145 image sharpening step
150 sharpening setting
155 image compression step
160 compression mode setting
165 file formatting step
170 metadata
175 user settings
180 digital image file
185 camera settings
300 detect power button press step
305 power on test
310 turn camera off step
315 turn camera on step
320 determine power button depress time step
325 depress time test
330 set default photography mode step
335 set previous photography mode step
350 determine power button depress sequence step
355 single or double press test
360 determine power button depress pressure step
365 light or heavy pressure test
400 detect user control press step
405 determine user control depress sequence step
410 single or double press test
415 set previous photography mode step
420 interactive photography mode selection process step
425 set selected photography mode step

1. A digital camera having a plurality of photography modes, comprising:
an imaging sensor;
an optical system for imaging a scene onto the imaging sensor;
an image capture control for initiating an image capture operation;
a photography mode user interface for selecting between a plurality of photography modes, the photography modes having associated image capture and image processing settings;
a power control for turning the digital camera on or off, wherein when the camera is in an off state and the power control is activated with a first activation pattern the digital camera is turned on and set to operate in a default photography mode and when the power control is activated with a second activation pattern the digital camera is turned on and set to operate in a previously selected photography mode.

2. The digital camera of claim 1 wherein the power control is a power button.

3. The digital camera of claim 2 wherein the power button is a mechanical power button.

4. The digital camera of claim 2 wherein the power button is a touch-sensitive surface.

5. The digital camera of claim 2 wherein the first activation pattern is a short duration button press of the power button having a time duration less than a predetermined threshold and the second activation pattern is a long duration button press of the power button having a time duration greater than the predetermined threshold.

6. The digital camera of claim 2 wherein the first activation pattern is a long duration button press of the power button having a time duration greater than a predetermined threshold and the second activation pattern is a short duration button press of the power button having a time duration less than the predetermined threshold.

7. The digital camera of claim 2 wherein the first activation pattern is a single button press of the power button and the second activation pattern is a double button press of the power button.

8. The digital camera of claim 2 wherein the first activation pattern is a double button press of the power button and the second activation pattern is a single button press of the power button.

9. The digital camera of claim 2 wherein the power button is pressure sensitive, and wherein the first activation pattern is a light-pressure button press of the power button having a pressure less than a predetermined threshold and the second activation pattern is a heavy pressure button press of the power button having a pressure greater than the predetermined threshold.

10. The digital camera of claim 2 wherein the power button is pressure sensitive, and wherein the first activation pattern is a light-pressure button press of the power button having a pressure less than a predetermined threshold and the second activation pattern is a heavy pressure button press of the power button having a pressure greater than the predetermined threshold.

11. The digital camera of claim 1 wherein the previously selected photography mode is the photography mode that the digital camera had been in when it was last turned off.

12. The digital camera of claim 1 wherein the previously selected photography mode is a user-designated favorite photography mode.

13. The digital camera of claim 1 wherein the activation of the power control initiates a process which detects the first and second activation patterns.

14. The digital camera of claim 1 further including:
a data processing system;
a memory system communicatively connected to the data processing system and storing instructions configured to cause the data processing system to:
capture a digital image with the imaging sensor in response to an activation of the image capture control; and
process the captured digital image according to the selected photography mode.

15. A digital camera having a plurality of photography modes, comprising:
an imaging sensor;
an optical system for imaging a scene onto the imaging sensor;
an image capture control for initiating an image capture operation;
a power control for turning the digital camera on or off;
a photography mode user interface for selecting between a plurality of photography modes, the photography modes having associated image capture and image processing settings, wherein when the photography mode user interface is activated with a first activation pattern the digital camera initiates an interactive photography mode selection process and when the photography mode user interface is activated with a second activation pattern the digital camera is set to operate in a previously selected photography mode.

16. The digital camera of claim 15 wherein the photography mode user interface includes a photography mode button.

17. The digital camera of claim 15 wherein the first activation pattern is a long duration button press of the photography mode button having a time duration greater than a predetermined threshold and the second activation pattern is a short duration button press of the photography mode button having a time duration less than the predetermined threshold.

18. The digital camera of claim 15 wherein the first activation pattern is a short duration button press of the photography mode button having a time duration less than a predetermined threshold and the second activation pattern is a long duration button press of the photography mode button having a time duration greater than the predetermined threshold.

19. The digital camera of claim 15 wherein the first activation pattern is a single button press of the photography mode button and the second activation pattern is a double button press of the photography mode button.

20. The digital camera of claim 15 wherein the previously selected photography mode is the photography mode that the digital camera had been in when it was last turned off.

21. The digital camera of claim 15 wherein the previously selected photography mode is the photography mode that had been selected previous to the currently selected photography mode.
